(19) United States
(12) Patent Application Publication
(10) Pub. No.: US 2011/0026756 A1
(43) Pub. Date: Feb. 3, 2011

(54) DISPLAY DEVICE

(75) Inventors: ZHENG-HENG SUN, Tu-Cheng (TW); AN-GANG LIANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., ShenZhen City (CN); HON HAI PRECISION INDUSTRY CO., LTD., Tu-Cheng (TW)

(21) Appl. No.: 12/606,201

(22) Filed: Oct. 27, 2009

(30) Foreign Application Priority Data
Jul. 30, 2009 (CN) 200910305018.1

(51) Int. Cl. H04R 1/02

(52) U.S. Cl. 381/388

(57) ABSTRACT

A display device includes a display, and a pair of sound boxes. The sound boxes are adjustably fixed to the display via at least two fixing members.

### BACKGROUND

1. Technical Field

The present disclosure relates to a display device.

2. Description of Related Art

With the widespread use of computers, the computers are playing a more and more important role in people's lives. Most people choose a desktop computer for family use. Compared to notebook computers, desktops are typically more reasonably priced and easy to upgrade. However, desktop computers require many peripherals, such as speakers, keyboard, mouse and so on to fully take advantage of them. These computer peripherals take up a lot of a desk space, making the desk crowded and messy.

### BRIEF DESCRIPTION OF THE DRAWINGS

FIG. 1 is an exploded, isometric view of an exemplary embodiment of a display device.

FIG. 2 is an isometric view of a sound box of the display device of FIG. 1, with upper portions of the sound box cut away.

FIGS. 3 and 4 are assembled, isometric views of the display device of FIG. 1, but viewed from different perspectives.

### DETAILED DESCRIPTION

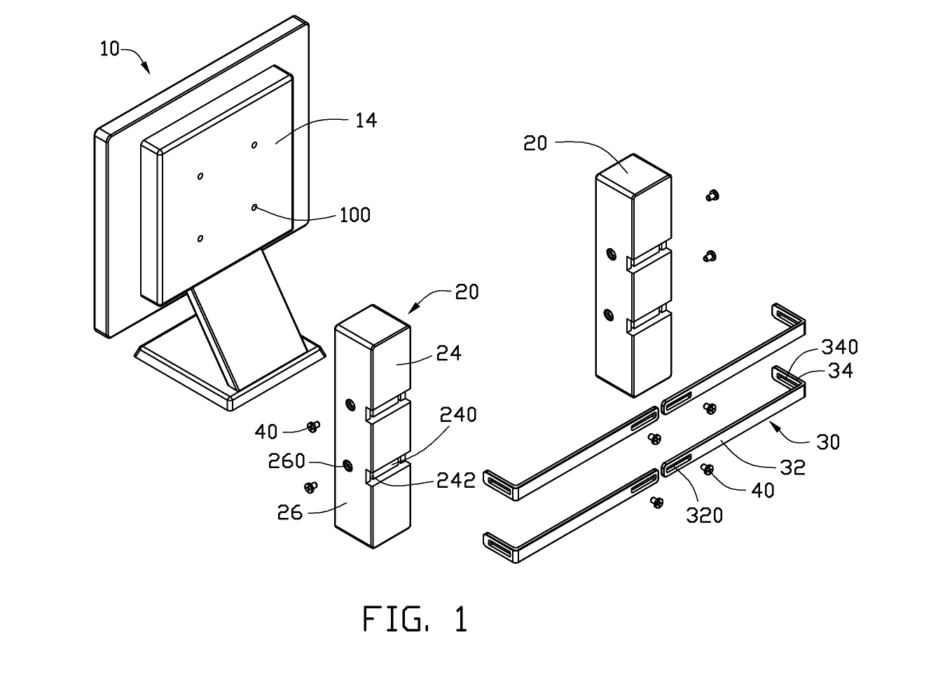

Referring to FIG. 1, an exemplary embodiment of a display device includes a display 10, a pair of sound boxes 20, four fixing members 30, and eight fasteners 40. In this embodiment, the fasteners 40 are screws.

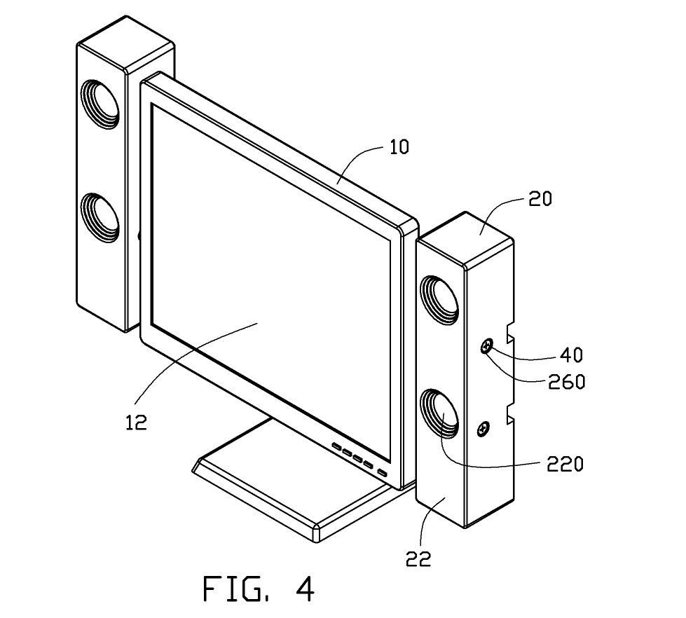

The display 10 has a conventional structure. The display 10 includes a screen 12 (referring to FIG. 4), and a rear cover 14 attached to the back of the screen 12. Four mounting holes 100 are defined in a middle portion of the rear cover 14.

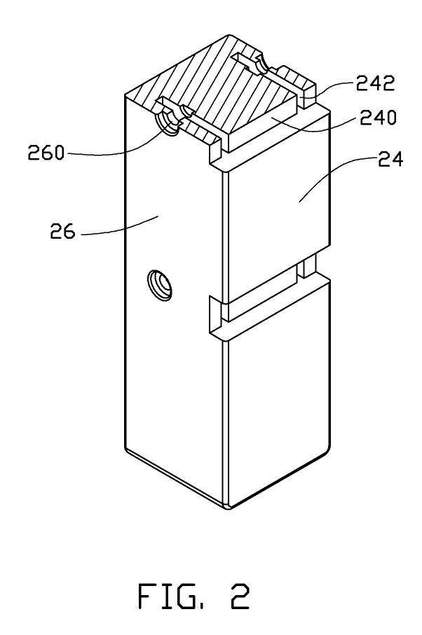

Referring to FIGS. 2 and 4, each of the sound boxes 20 includes a pair of parallel receiving notches 240 defined in a rear wall 24 thereof one above another, two pairs of parallel fixing slots 242 defined therein fro each receiving notch 240 extending in a direction perpendicular to the rear wall 24 and communicating with the receiving notches 240. A pair of speakers 220 set on a front wall 22 thereof. Two pairs of fixing holes 260 respectively defined in opposite sidewalls 26 thereof and communicating the corresponding fixing slots 242.

Each of the fixing members 30 includes a first bar 32, and a second bar 34 perpendicularly extending from one end of the first bar 32. The first bar 32 is longer than the second bar 34. A long sliding slot 320 is defined in the other end of the first bar 32. A long sliding slot 340 is defined in the second bar 34.

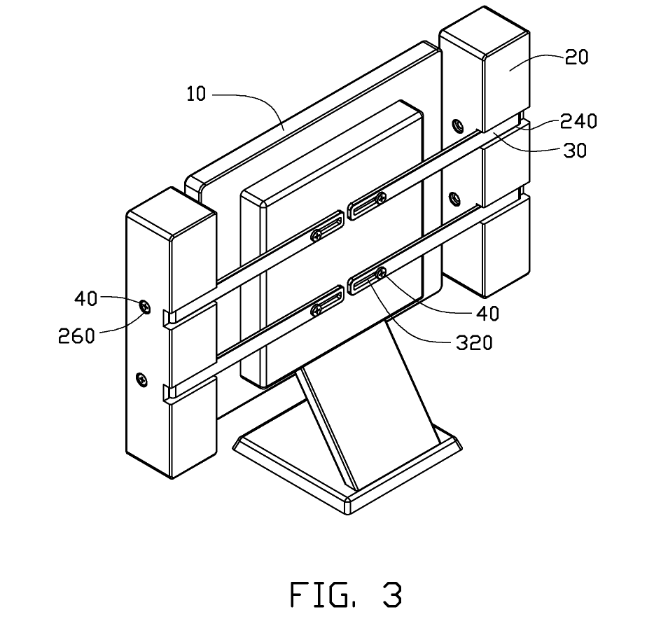

Referring to FIGS. 3 and 4, in assembly of the display device, the sound boxes 20 are attached to the display 10 by the fixing members 30, with the speakers 220 in alignment with the screen 12 of the display 10. The first bars 32 of the four fixing members 30 respectively engage in the four receiving notches 240 of the two sound boxes 20. The second bars 34 of the fixing members 30 selectively engage in the fixing slots 242 of the sound boxes 20. Four fasteners 40 respectively extend through the corresponding fixing holes 260 and the corresponding fixing slots 242 and slidably engage in the long sliding slots 340 of the second bars 34 of the fixing members 30. Four fasteners 40 respectively and slidably extend through the long sliding slots 320 of the first bars 32 of the fixing members 30 to engage in the mounting holes 100 of the rear cover 14 of the display 10. The second bars 34 of the fixing members 30 are capable of selectively engaging in the fixing slots 242 of the sound boxes 20 and the long sliding slots 320, 340 of the fixing members are capable of slidably engaging with the fasteners 40. Thus, the sound boxes 20 can be adjustably attached to the display 10. If the sound boxes 20 are much heavy, the fixing members 30 are adjusted to make the sound boxes 20 lean against the display 10, to prevent the sound boxes 20 from rotating down or tilting to one side.

In other exemplary embodiment, the display device may include two fixing members 30. Each of the sound boxes 20 may include one receiving notch 240, one fixing hole 260, and one fixing slot 242.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A display device comprising:
a display;
a pair of sound boxes; and
at least two fixing members adjustably attaching the sound boxes to the display.

2. The display device of claim 1, wherein each of the at least two fixing members includes a first bar, and a second bar perpendicular to the first bar, the first bar is adjustably mounted on the display and the second bar is adjustably mounted on the sound box.

3. The display device of claim 2, wherein the display comprises a screen, and a rear cover attached to the back of the screen, a plurality of mounting holes is defined in the rear cover, the first bar of each of the fixing members defines a long sliding slot, a fastener slidably extends through the long sliding slot of the first bar to engage in a corresponding one of the plurality of mounting holes.

4. The display device of claim 3, wherein the second bar of each of the fixing members defines a long sliding slot, a fastener extends through the long sliding slot of the second bar to engage with the sound box.

5. The display device of claim 4, wherein at least two fixing members comprise two fixing members; each of the sound boxes includes a receiving notch for receiving the first bar of a corresponding one of the two fixing members, at least one fixing slot communicating with the receiving notch for receiving the second bar of the corresponding fixing member, and one fixing hole communicating with one of the at least one fixing slot for allowing the fastener extending therethrough to engage in the long sliding slot of the second bar.

6. The display device of claim 5, wherein at least one fixing slot comprises two parallel fixing slots extending in a direction perpendicular to the rear wall; the receiving slot is horizontally defined in a rear wall of the sound box, the second bar of the corresponding fixing member selectively engage in one of the fixing slots.

7. The display device of claim 6, wherein each fixing hole respectively defined in opposite sidewalls thereof, the fastener extends through the corresponding fixing hole, the long sliding slot of the second bar, and the corresponding fixing slot.
